(19) United States
(12) Patent Application Publication
(10) Pub. No.: US 2022/0301293 A1
(43) Pub. Date: Sep. 22, 2022

(54) MODEL GENERATION APPARATUS, MODEL GENERATION METHOD, AND RECORDING MEDIUM

(71) Applicant: NEC CORPORATION, Tokyo (JP)

(72) Inventor: Tetsuo INOSHITA, Tokyo (JP)

(73) Assignee: NEC CORPORATION, Tokyo (JP)

(21) Appl. No.: 17/640,571

(22) PCT Filed: Sep. 5, 2019
(86) PCT No.: PCT/JP2019/035014

§ 371 Date: Mar. 4, 2022

(51) Int. Cl. G06V 10/778; G06V 10/764; G06V 10/776

(52) U.S. Cl. CPC G06V 10/7784; G06V 10/764; G06V 10/776

(57) ABSTRACT

A plurality of recognition units respectively recognize image data using a learned model and output degrees of reliability corresponding to classes regarded as recognition targets by respective recognition units. A reliability generation unit generates degrees of reliability corresponding to a plurality of target classes based on the degrees of reliability output from the plurality of recognition units. A target model recognition unit recognizes the same image data as that recognized by the recognition units, by using a target model, and adjusts parameters of the target model in order to match the degrees of reliability corresponding to the target classes generated by a generation unit that outputs degrees of reliability corresponding to the target classes with the degrees of reliability corresponding to the target classes output from the target model recognition unit.

### TECHNICAL FIELD

The present invention relates to a technique for generating a new model using a plurality of learned models.

### BACKGROUND ART

A technique is known for transferring a teacher model learned using a large network to a small student model. For example, Patent Document 1 describes a technique for creating a DNN classifier by learning a student DNN model with a larger and more accurate teacher DNN model.

### PRECEDING TECHNICAL REFERENCES

### Patent Document

Patent Document 1: Japanese National Publication of International Patent Application No. 2017-531255

### SUMMARY

### Problem to be Solved by the Invention

In a case of generating a student model using a teacher model as in the above technique, it is necessary that recognition target classes between the teacher model and the student model are matched. Hence, in a case of generating the student model having a new class different from that of the existing teacher model, it is necessary to re-learn the teacher model so as to correspond to the new class. However, since the teacher model is formed by a large-scale network, there is a problem that the re-learning of the teacher model takes time.

It is one object of the present invention to quickly and conveniently generate a student model with various recognition target classes using a large-scale and high-precision teacher model.

### Means for Solving the Problem

According to an example aspect of the present invention, there is provided a model generation apparatus including:

a plurality of recognition units configured to recognize image data using a learned model and output degrees of reliability corresponding to classes regarded as recognition targets by respective recognition units;

a reliability generation unit configured to generate degrees of reliability corresponding to a plurality of target classes based on the degrees of reliability output from the plurality of recognition units;

a target model recognition unit configured to recognize the image data using a target model and output degrees of reliability corresponding to the target classes; and

a parameter adjustment unit configured to adjust parameters of the target model in order to match the degrees of reliability corresponding to the target classes generated by the reliability generation unit with the degrees of reliability corresponding to the target classes output from the target model recognition unit.

According to another example aspect of the present invention, there is provided a model generation method including:

recognizing image data by a plurality of recognition units using a learned model, and outputting degrees of reliability corresponding to classes regarded as recognition targets by respective recognition units;

generating first degrees of reliability corresponding to a plurality of target classes based on the degrees of reliability output from the plurality of recognition units;

recognizing the image data using a target model and outputting second degrees of reliability corresponding to the target classes; and

adjusting parameters of the target model in order to match the first degrees of reliability with the second degrees of reliability.

According to still another example aspect of the present invention, there is provided a recording medium storing a program, the program causing a computer to perform a process including:

recognizing image data by a plurality of recognition units using a learned model, and outputting degrees of reliability corresponding to classes regarded as recognition targets by respective recognition units;

generating first degrees of reliability corresponding to a plurality of target classes based on degrees of reliability output from the plurality of recognition units;

recognizing the image data using a target model and outputting second degrees of reliability corresponding to the target classes; and

adjusting parameters of the target model in order to match the first degrees of reliability with the second degrees of reliability.

### Effect of the Invention

According to the present invention, it is possible to quickly and conveniently generate a student model having various recognition target classes using a large-scale and high-precision teacher model.

### BRIEF DESCRIPTION OF THE DRAWINGS

FIG. 1 is a conceptual diagram illustrating a basic principle of a present example embodiment.

FIG. 2 is a block diagram illustrating a hardware configuration of a model generation apparatus according to an example embodiment.

FIG. 3 is a block diagram illustrating a functional configuration of a model generation apparatus according to a first example embodiment.

FIG. 4 illustrates an example for generating a teacher model reliability.

FIG. 5 is a flowchart of a model generation process.

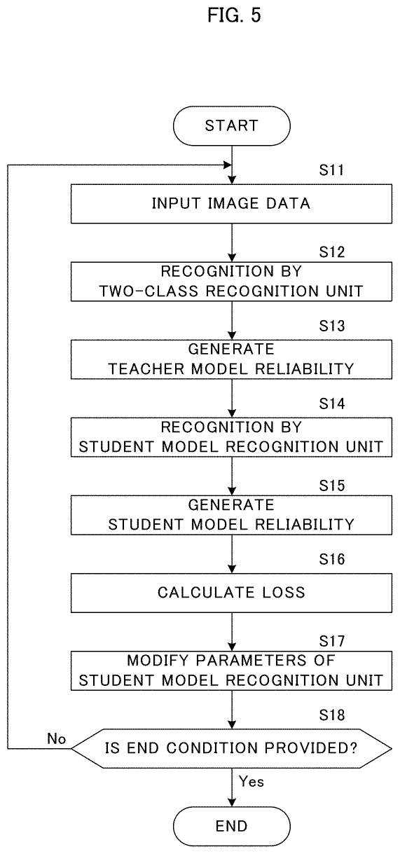

FIG. 6 is a block diagram illustrating a functional configuration of a model generation apparatus according to a second example embodiment.

FIG. 7 illustrates an example of recognition results by recognition units of the second example embodiment.

FIG. 8 is a block diagram illustrating a functional configuration of a model generation apparatus according to a third example embodiment.

### EXAMPLE EMBODIMENTS

[Explanation of Principle]

First, a basic principle of example embodiments of the present invention will be described. In the present example embodiment, a new student model is generated by distillation using a teacher model formed by a learned large-scale network. The “distillation” is a technique to transfer knowledge from a learned teacher model to an unlearned student model.

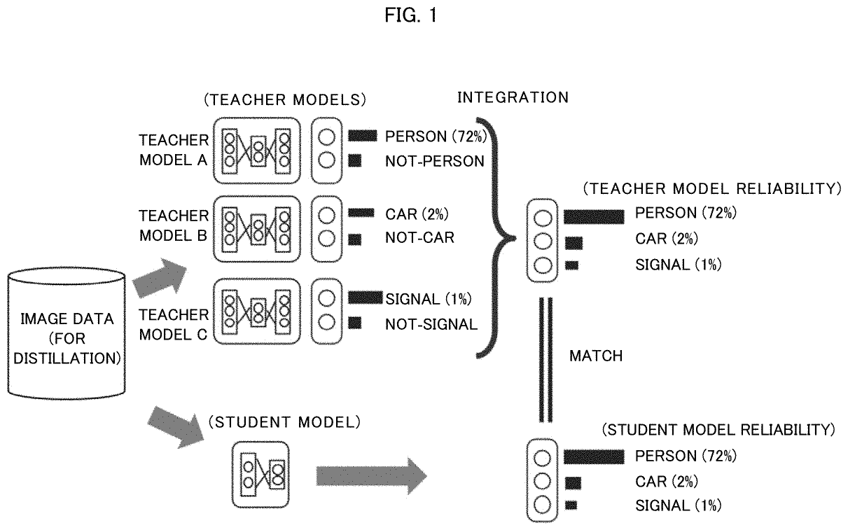

FIG. 1 is a conceptual diagram illustrating the basic principle of the present example embodiment. For instance, it is assumed that a new model is generated based on a need for an image recognition process used in a traffic monitoring system. Recognition target classes may be a “person”, a “car”, and a “signal”. In this case, a student model (hereinafter, also referred to as a “target model”) is prepared by using a relatively small-scale network capable of being installed at a traffic monitoring location or the like. The recognition target classes of the student model (hereinafter, also referred to as “target classes”) are three: the “person,” the “car,” and the “signal.”

Next, learned teacher models A to C are prepared using a large-scale network in advance. Each of the teacher models A to C recognizes an input image data. Here, since the target classes of the student models are the “person”, the “car”, and the “signal”, models that recognizes the “person”, the “car”, and the “signal” are prepared as the teacher models A to C, respectively. Specifically, the teacher model A recognizes whether the recognition target is the “person” and image data show the “person” or a “non-person” (hereinafter, it is shown using “Not”). Then, as a recognition result, the teacher model A outputs a degree of reliability indicating an accuracy of the recognition for each of the class “person” and the class “Not-person”. Similarly, the teacher model B recognizes whether the recognition target is the “car” and the image data show the “car” or a “Not-car”. Then, as a recognition result, the teacher model 13 outputs a degree of reliability indicating an accuracy of the recognition for each of the class “car” and the class “Not-car”. The teacher model C recognizes whether the recognition target is the “signal” and the image data show the “signal” or a “Not-signal”. Then, as a recognition result, the teacher model C outputs a degree of reliability indicating an accuracy of the recognition for each of the class “signal” and the class “Not-signal”.

Incidentally, the teacher models A to C are two-class recognition models that recognize two classes: a class indicating that the image data show a recognition target (in this example, a “person” or the like) (hereinafter, also referred to as a “positive class”) and a class indicating that the image data do not show the recognition target (a class indicated by “Not” and hereinafter, also referred to as a “negative class”). As described above, two classes indicating a presence and an absence of a certain recognition target are also referred to herein as “negative-type two class”.

Image data for distillation are input to the teacher models A to C and the student models. As the image data for distillation, image data collected at a location where the student model is placed is used. The teacher models A to C recognize the image data which are input respectively. The teacher model A recognizes whether or not the input image data show the “person”, and outputs a degree of reliability that is the “person” and a degree of reliability that is the “Not-person”. The teacher model B recognizes whether or not the input image data show the “car”, and outputs a degree of reliability that is the “car” and a degree of reliability that is the “Not-car”. The teacher model C recognizes whether or not the input image data show the “signal”, and outputs a degree of reliability that is the “signal” and a degree of reliability that is the “Not-signal”.

The recognition results by the teacher models A to C are integrated and a teacher model reliability is generated. The “teacher model reliability” is a reliability generated comprehensively on a teacher model side with respect to the input image data, and shows respective degrees of reliability for target classes, which are generated based on the recognition results by the teacher models A to C. Specifically, for certain image data X, the degree of reliability that is the “person” output by the teacher model A, the degree of reliability that is the “car” output by the teacher model B, and the degree of reliability that is the “signal” output by the teacher model C are integrated, and a teacher model reliability is generated. In the example of FIG. 1, when the certain image data X are input to the teacher models A to C, the teacher model A outputs 72% as a degree of reliability that is the “person”, the teacher model B outputs 2% as a degree of reliability that is the “car”, and the teacher model C outputs 1% as a degree of reliability that is the “signal”. Therefore, the teacher model reliability, which is generated by integrating these degrees of reliability, indicates 72% for the person, 2% for the car, and 1% for the signal. In practice, these ratios are used to normalize so that the sum is 100%.

On the other hand, the student model recognizes the same image data X and outputs a degree of reliability for each of the three target classes (the person, the car, and the signal). Here, since the recognition of image data is performed by an internal network where the parameters of the initial values are set, a recognition result of the student model basically differs from recognition results of the teacher models A to C. Therefore, the student model learns so as to output degrees of reliability corresponding to those of the teacher model reliability generated based on outputs of the teacher models A to C. Specifically, the internal parameters of the network forming the student model are modified so that the degree of reliability of each target class output by the student model matches with that of the teacher model reliability. In the example of FIG. 1, parameters of the student model are modified, so that when image data X are input, an output of the student model indicates ratios, such as 72% as the degree of reliability that is the “person”, 2% as the degree of reliability that is the “car”, and 1% as the degree of reliability that is the “signal”. Thus, by the so-called distillation technique, the student model is formed to simulate an output of the learned teacher model.

In this technique, when a model of the negative-type two class is prepared for various recognition targets as a teacher model, it becomes possible to adapt to any types of target classes of each student model. For example, if recognition target classes of a “bicycle”, a “pedestrian bridge”, and the like are further prepared as teacher models, a new student model using the “person”, the “car”, the “signal”, and the “bicycle” as target classes, and a new student model using the “person”, the “car”, the “signal”, and the “pedestrian bridge” as the target classes can be generated. Therefore, it becomes possible to generate a new target model by combining high-accuracy teacher models in accordance with various needs.

### First Example Embodiment

Next, a first example embodiment of the present invention will be described.

(Hardware Configuration)

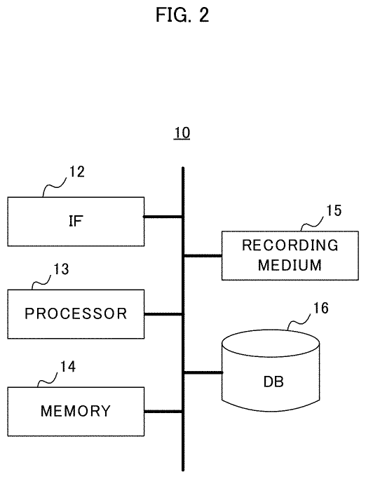

FIG. 2 is a block diagram illustrating a hardware configuration of a model generation apparatus according to the first example embodiment. As illustrated, the model generation apparatus 10 includes an interface (IF) 12, a processor 13, a memory 14, a recording medium 15, and a database (DB) 16.

The interface 12 communicates with an external apparatus. Specifically, the interface 12 is used to externally input image data for distillation or to output finally determined parameters for a student model to the external apparatus.

The processor 13 is a computer such as a CPU (Central Processing Unit) or a GPU (Graphics Processing Unit) in addition to a CPU, and controls the entire model generation apparatus 10 by executing a program prepared in advance. The memory 14 includes a ROM (Read Only Memory), a RAM (Random Access Memory), or the like. The memory 14 stores various programs to be executed by the processor 13. Also, the memory 14 is used as a work memory during executions of various processes by the processor 13.

The recording medium 15 is a non-volatile and non-transitory recording medium such as a disk-shaped recording medium, a semiconductor memory, or the like, and is formed to be detachable from the model generation apparatus 10. The recording medium 15 records various programs, which are executed by the processor 13. When the model generation apparatus 10 performs a model generation process, a program recorded on the recording medium 15 is loaded into the memory 14 and is executed by the processor 13.

The database 16 stores image data for distillation used in the model generation process. In addition to the above, the model generation apparatus 10 may include an input device such as a keyboard, a mouse, or the like, and a display device, and the like.

(Functional Configuration)

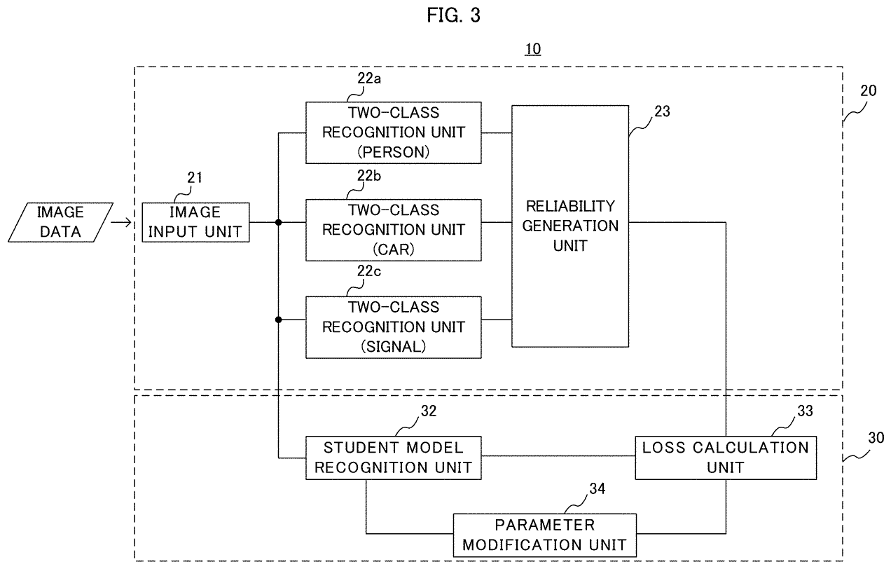

Next, a functional configuration of the model generation apparatus 10 will be described. FIG. 3 is a block diagram illustrating the functional configuration of the model generation apparatus 10. The model generation apparatus 10 roughly includes a teacher model unit 20 and a student model unit 30. The teacher model unit 20 includes an image input unit 21, two-class recognition units 22a to 22c, and a reliability generation unit 23. Moreover, the student model unit 30 includes a student model recognition unit 32, a loss calculation unit 33, and a parameter modification unit 34.

Image data for distillation are input into the image input unit 21. The image data for distillation are usually taken at a location where an image recognition apparatus using a student model is used. The image input unit 21 supplies the same image data to the two-class recognition units 22a to 22c and the student model recognition unit 32.

The two-class recognition units 22a to 22c are recognition units that use a teacher model learned in advance, and respectively recognize a negative-type two class, that is, recognize a presence and an absence of a recognition target. Specifically, the two-class recognition unit 22a recognizes whether the image data show the “person” or the “Not-person”, and the two-class recognition unit 22b recognizes whether the image data show the “car” or the “Not-car”, and the two-class recognition unit 22c recognizes whether the image data show the “signal” or the “Not-signal”. The two-class recognition units 22a to 22c recognize image data for distillation supplied from the image input unit 21, and each of the units 22a to 22c outputs degrees of reliability of a positive class and a negative class as the recognition results. For instance, the two-class recognition unit 22a outputs a degree of reliability for the positive class “person” and a degree of reliability for the negative class “Not-person”. Similarly, the two-class recognition unit 22b outputs a degree of reliability for the positive class “car” and a degree of reliability for the negative class “Not-car”, and the two-class recognition unit 22c outputs a degree of reliability for the positive class “signal” and a degree of reliability for the negative class “Not-signal”.

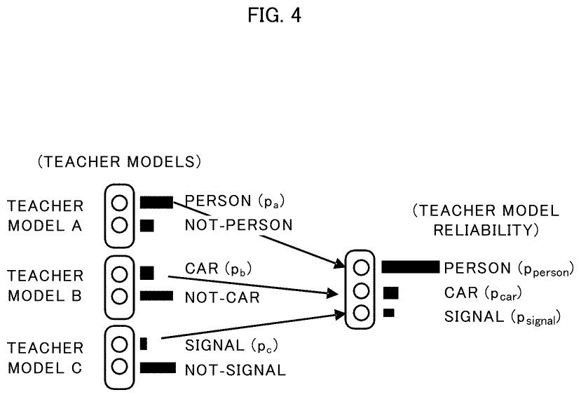

The reliability generation unit 23 generates a teacher model reliability based on the recognition results output from the two-class recognition units 22a to 22c. Specifically, the reliability generation unit 23 integrates the degrees of reliability for the positive class output respectively from the two-class recognition units 22a to 22c. As illustrated in FIG. 4, when a degree of reliability for the positive class “person” output by the two-class recognition unit 22a is “pₐ”, a degree of reliability for the positive class “car” output by the two-class recognition unit 22b is “p_{b}”, and a degree of reliability for the positive class “signal” output by the two-class recognition unit 22c is “p_{c}”, the reliability generation unit 23 calculates a degree pₚₑᵣₛₒₙ of reliability for the class “person”, a degree p_{car} of reliability for the class “car”, and a degree p_{signal} of reliability for the class “signal” as follows.

$$[ Math 1 ]$$

$${p}_{person} = \frac{{p}_{a}}{{p}_{a} + {p}_{b} + {p}_{c}} \qquad ( 1 )$$

$${p}_{car} = \frac{{p}_{b}}{{p}_{a} + {p}_{b} + {p}_{c}} \qquad ( 2 )$$

$${p}_{signal} = \frac{{p}_{a}}{{p}_{a} + {p}_{b} + {p}_{c}} \qquad ( 3 )$$

Incidentally, similar to the example of FIG. 1, if the degree of reliability for the positive class “person” output by the two-class recognition unit 22a is 72%, the degree of reliability for the positive class “car” output by the two-class recognition unit 22b is 2%, and the degree of reliability for the positive class “signal” output by the two-class recognition unit 22c is 1%, the degree pₚₑᵣₛₒₙ of reliability for the class “person” is as follows.

$$[ Math 2 ]$$

$${p}_{person} \frac{{p}_{a}}{{p}_{a} + {p}_{b} + {p}_{c}} = \frac{72 \%}{72 \% + 2 \% + 1 \%}$$

In practice, the reliability generation unit 23 normalizes and uses the degree of reliability for each class obtained as described above, so that a total becomes 100%. When the above example degrees of reliability are normalized, the degrees Pₚₑᵣₛₒₙ, Pₑₐᵣ, and P_{signal} of reliability for respective classes are as follows.

Pₚₑᵣₛₒₙ=96%,P_{car}=3%=,P_{signal}=1%

The reliability generation unit 23 supplies the generated teacher model reliability to the loss calculation unit 33.

The student model recognition unit 32 corresponds to a target model to newly create, and includes a deep neural network (DNN) or the like therein. The student model recognition unit 32 recognizes the same image data as image data recognized by the two-class recognition units 22a to 22c, and outputs a recognition result to the loss calculation unit 33. In this example embodiment, the student model recognition unit 32 outputs a degree of reliability for the class “person”, a degree of reliability for the class “car”, and a degree of reliability for the class “signal” as the recognition result, since the “person”, the “car”, and the “signal” are set as target classes. These degrees of reliability, which are output by the student model recognition unit 32, are also referred to as collectively “student model reliability”. Incidentally, the student model recognition unit 32 outputs degrees of reliability so that the total of the degrees of reliability for these three classes becomes 100%.

The loss calculation unit 33 compares the degrees of the teacher model reliability output from the reliability generation unit 23 with the degrees of the student model reliability output from the student model recognition unit 32, calculates a loss (difference), and supplies it to the parameter modification unit 34. The parameter modification unit 34 modifies parameters of the internal network of the student model recognition unit 32, in order to reduce the loss calculated by the loss calculation unit 33, optimally to zero. The fact that the loss between the teacher model reliability and the student model reliability becomes 0 means that the recognition result (degrees of reliability) of the teacher model unit 20 and the recognition result (degrees of reliability) of the student model recognition unit 32 match with each other for the same image data. Therefore, it is possible to transmit knowledge of the teacher model to the student model recognition unit 32, and to generate a high-accuracy target model.

(Model Generation Process)

Next, a model generation process will be described. FIG. 4 is a flowchart of the model generation process by the model generation apparatus 10. This process is realized by the processor 13 illustrated in FIG. 2, which executes a program prepared in advance.

First, image data for distillation are input from the image input unit 21 to the two-class recognition units 22a to 22c and the student model recognition unit 32 (step S11). The two-class recognition units 22a to 22c recognize the image data, respectively calculate degrees of reliability, and output them to the reliability generation unit 23 (step S12). The reliability generation unit 23 generates degrees of the teacher model reliability based on the degrees of reliability input from the two-class recognition units 22a to 22c (step S13).

On the other hand, the student model recognition unit 32 recognizes the same image data (step S14), and generates the student model reliability as recognition result (step S15). The loss calculation unit 33 calculates a loss between the teacher model reliability generated by the reliability calculation unit 23 and the student model reliability generated by the student model recognition unit 32 (step S16). The parameter modification unit 34 modifies internal parameters of the student model recognition unit so as to reduce the losses calculated by the loss calculation unit 33 (step S17).

Next, the model generation apparatus 10 determines whether or not a predetermined end condition is provided (step S18). The model generation apparatus 10 repeats steps S11 to S17 until the end condition is provided, and when the end condition is provided (step S18: Yes), the process is terminated. Note that the “predetermined end condition” is a condition concerning a number of repetitions or a change degree in a value of the loss, or the like, and any one of the methods adopted as a learning procedure for many types of deep learning can be used. The model generation apparatus 10 performs the model generation process described above for all sets of the image data for distillation prepared in advance. The student model recognition unit 32 thus generated is used in the image recognition apparatus as a learned recognition unit.

(Modification)

In the above-described example embodiment, the reliability generation unit 23 generates the teacher model reliability using values themselves of the reliability output from the two-class recognition units 22a to 22c as shown in the above-described equations (1) to (3). Instead, the reliability generation unit 23 may generate the teacher model reliability by weighting the values of the reliability output from the two-class recognition units 22a to 22c. For instance, when weights for degrees of the reliability output from the two-class recognition units 22a to 22c are “α”, “β”, and “γ”, the reliability generation unit 23 calculates the degree pₚₑᵣₛₒₙ of reliability for the class “person”, the degree p_{car} of reliability for the class “car”, and the degree p_{signal} of reliability for the class “signal” as follows.

$$[ Math 3 ]$$

$${p}_{person} = \frac{α {p}_{a}}{α {p}_{a} + β {p}_{b} + γ {p}_{c}} \qquad ( 4 )$$

$${p}_{car} = \frac{β {p}_{b}}{{α}_{P a} + β {p}_{b} + γ {p}_{c}} \qquad ( 5 )$$

$${p}_{signal} = \frac{γ {p}_{a}}{α {p}_{a} + β {p}_{b} + γ {p}_{c}} \qquad ( 6 )$$

In this case, among the reliabilities output from the two-class recognition units 22a to 22c, it is preferable to apply a large weight particularly with respect to a degree of reliability being a small value. For instance, when there is a difference in the degrees of reliability output from the two-class recognition units 22a to 22c, it is preferable to apply a weight larger than that of the highly reliable “person (72%)” to the degree of reliability for the “car (2%)” or the “signal (1%)” being a lower degree of reliability. In the above example, the weights “β” and “γ” are set to be values larger than the weight “a”. By this setting, it is possible to prevent knowledge for recognition transmitted from the teacher model to the student model recognition unit 32 from being too biased towards a particular class, and it is possible to generate a target model capable of appropriately recognizing various recognition targets.

### Second Example Embodiment

Next, a second example embodiment of the present invention will be described. In the above described first example embodiment, each of the two-class recognition units 22a to 22c used in the teacher model unit 20 recognizes a presence and an absence of one recognition target, that is, the positive class and the negative class for one recognition target. In contrast, the second embodiment is different from the first embodiment in that a recognition unit for recognizing a plurality of recognition targets is used. Incidentally, a hardware configuration of a model generation apparatus according to the second example embodiment is the same as that of the first example embodiment shown in FIG. 2.

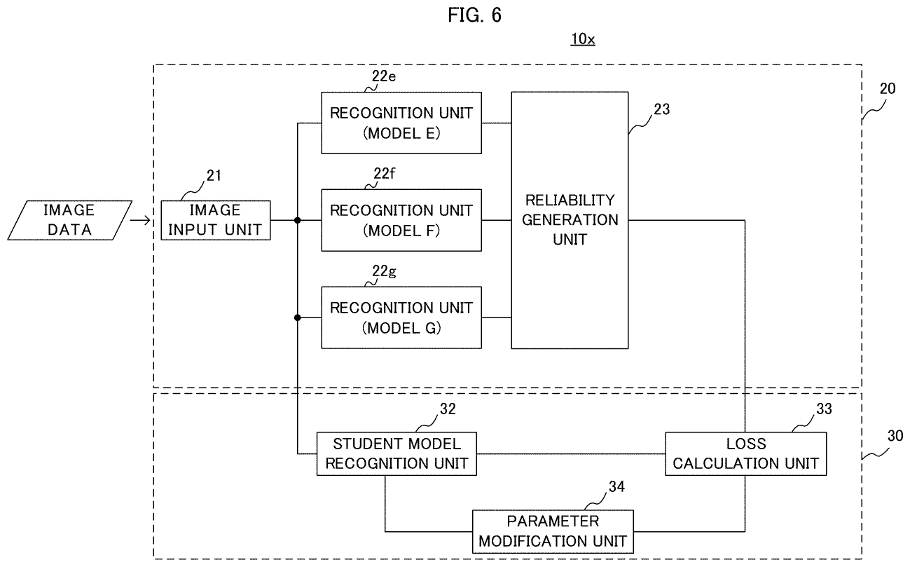

FIG. 6 is a block diagram illustrating a functional configuration of a model generation apparatus 10x according to the second example embodiment. As understood from comparison with FIG. 3, different from the first example embodiment, instead of including the two-class recognition units 22a to 22c, the model generation apparatus 10x includes recognition units 22e to 22g; however, other units are the same as those of the model generation apparatus 10, and operate in the same manner.

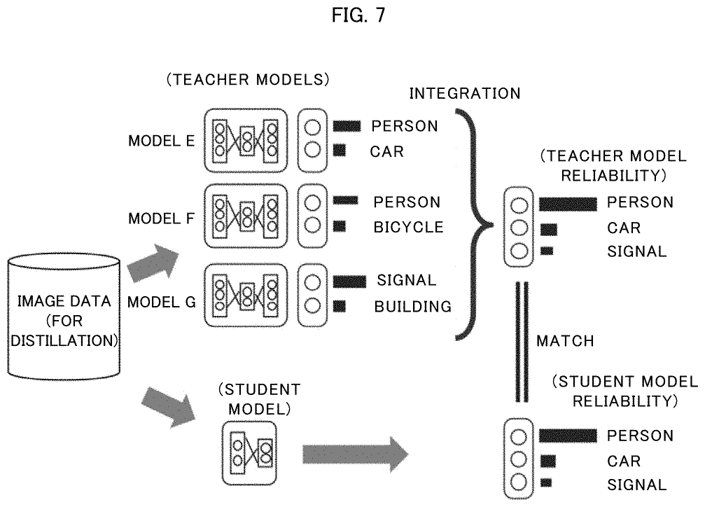

For example, as illustrated in FIG. 7, the recognition unit 22e recognizes the “person” and the “car” as the recognition target classes, the recognition unit 22f recognizes the “person” and the “bicycle” as the recognition target classes, and the recognition unit 22g recognizes the “signal” and a “building” as the recognition target classes. On the other hand, similar to the first example embodiment, the student model recognition unit 32 recognizes the “person”, the “car”, and the “signal” as the recognition target classes. In this case, the reliability calculation unit 23 integrates degrees of reliability for the “person” and the “car” output from the recognition unit 22e, a degree of reliability for the “car” output from the recognition unit 22f, and a degree of reliability for the “signal” output from the recognition unit 22g, and generates the teacher model reliability. Then, the parameter modification unit 34 adjusts the parameters of the student model recognition unit 32 so that the teacher model reliability and the student model reliability are matched.

As described above, even in a case where the recognition unit used in the teacher model unit 20 is a model including a plurality of recognition target classes, the target model can be generated by utilizing the knowledge of the teacher model similarly to the first example embodiment.

### Third Example Embodiment

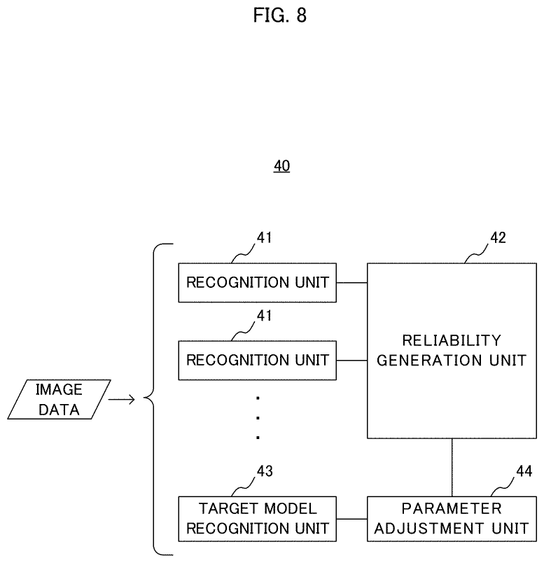

Next, a third example embodiment of the present invention will be described. FIG. 8 shows a functional configuration of a model generation apparatus 40 according to the third example embodiment. Incidentally, the model generation apparatus 40 is realized by the hardware configuration shown in FIG. 2.

As illustrated in FIG. 8, the model generation apparatus 40 includes a plurality of recognition units 41, a reliability generation unit 42, a target model recognition unit 43, and a parameter adjustment unit 44. Each of the plurality of recognition units 41 recognizes image data using a learned model, and outputs a degree of reliability for each class which the recognition unit 41 regards as a recognition target. The reliability generation unit 42 generates a degree of reliability for each of a plurality of target classes based on degrees of reliability output from the plurality of recognition units 41. Note that the “target model” is a model that the model generation apparatus 40 attempts to generate, and the “target class” is a recognition target class of the target model.

By using the target model, the target model recognition unit 43 recognizes the same image data recognized by the plurality of recognition units 41, and outputs respective degrees of reliability for the target classes. The parameter adjustment unit 44 adjusts the parameters of the target model in order to match the respective degrees of reliability for the target classes generated by the reliability generation unit 42 with the respective degrees of reliability for the target classes output by the target model recognition unit 43. Accordingly, the target model can be generated using the plurality of learned recognition units 41.

A part or all of the example embodiments described above may also be described as the following supplementary notes, but not limited thereto.

(Supplementary Note 1)

1. A model generation apparatus comprising:

a plurality of recognition units configured to recognize image data using a learned model and output degrees of reliability corresponding to classes regarded as recognition targets by respective recognition units;

a reliability generation unit configured to generate degrees of reliability corresponding to a plurality of target classes based on the degrees of reliability output from the plurality of recognition units;

a target model recognition unit configured to recognize the image data using a target model and output degrees of reliability corresponding to the target classes; and

a parameter adjustment unit configured to adjust parameters of the target model in order to match the degrees of reliability corresponding to the target classes generated by the reliability generation unit with the degrees of reliability corresponding to the target classes output from the target model recognition unit.

(Supplementary Note 2)

2. The model generation apparatus according to supplementary note 1, wherein the reliability generation unit is configured to integrate degrees of reliability for classes included in the plurality of target classes among the degrees of reliability corresponding to classes output from the plurality of recognition units, and to generate the degrees of reliability corresponding to the target classes.

(Supplementary Note 3)

3. The model generation apparatus according to supplementary note 1 or 2, wherein each of the plurality of recognition units is a two-class recognition unit that outputs a degree of reliability for a positive class and a degree of reliability for a negative class, the positive class indicating that the image data include a recognition target, the negative class indicating that the image data do not include the recognition target.

(Supplementary Note 4)

4. The model generation apparatus according to supplementary note 3 or 4, wherein the reliability generation unit is configured to generate the degrees of reliability corresponding to the plurality of target classes by using degrees of reliability for the positive classes output from the plurality of recognition units.

(Supplementary Note 5)

5. The model generation apparatus according to supplementary note 4, wherein the reliability generation unit is configured to generate the degrees of reliability corresponding to the plurality of target classes, based on each ratio of degrees of reliability for positive classes with respect to a total of the degrees of reliability for the positive classes output from the plurality of recognition units.

(Supplementary Note 6)

6. The model generation apparatus according to supplementary note 5, wherein the reliability generation unit is configured to set a value where the ratio is normalized, to a degree of reliability for each target class.

(Supplementary Note 7)

7. The model generation apparatus according to supplementary notes 3 through 6, wherein each of the plurality of recognition units is configured to recognize a different recognition target.

(Supplementary Note 8)

8. The model generation apparatus according to supplementary note 7, wherein each of the plurality of recognition units is configured to recognize a recognition target of one class among the plurality of target classes.

(Supplementary Note 9)

9. The model generation apparatus according to supplementary note 1 or 2, wherein each of the plurality of recognition units is configured to recognize a plurality of different recognition targets.

(Supplementary Note 10)

10. The model generation apparatus according to supplementary note 9, wherein each of the plurality of recognition units is configured to recognize at least one class as the recognition target among the plurality of target classes.

(Supplementary Note 11)

11. A model generation method comprising:

recognizing image data by a plurality of recognition units using a learned model, and outputting degrees of reliability corresponding to classes regarded as recognition targets by respective recognition units;

generating first degrees of reliability corresponding to a plurality of target classes based on the degrees of reliability output from the plurality of recognition units;

recognizing the image data using a target model and outputting second degrees of reliability corresponding to the target classes; and

adjusting parameters of the target model in order to match the first degrees of reliability with the second degrees of reliability.

(Supplementary Note 12)

12. A recording medium storing a program, the program causing a computer to perform a process comprising:

recognizing image data by a plurality of recognition units using a learned model, and outputting degrees of reliability corresponding to classes regarded as recognition targets by respective recognition units;

generating first degrees of reliability corresponding to a plurality of target classes based on degrees of reliability output from the plurality of recognition units;

recognizing the image data using a target model and outputting second degrees of reliability corresponding to the target classes; and

adjusting parameters of the target model in order to match the first degrees of reliability with the second degrees of reliability.

While the invention has been described with reference to the example embodiments and examples, the invention is not limited to the above example embodiments and examples. It will be understood by those of ordinary skill in the art that various changes in form and details may be made therein without departing from the spirit and scope of the present invention as defined by the claims.

### DESCRIPTION OF SYMBOLS

10, 10x, 40 Model generation apparatus
22a to 22c 2 Class recognition unit
22e to 22g Recognition unit
23 Reliability generation unit
32 Student model recognition unit
33 Loss calculation unit
34 Parameter modification unit

1. A model generation apparatus comprising:
a memory storing instructions; and
one or more processors configured to execute the instructions to:
recognize image data by a plurality of recognition units using a learned model and output degrees of reliability corresponding to classes regarded as recognition targets by respective recognition units;
generate degrees of reliability corresponding to a plurality of target classes based on the degrees of reliability output from the plurality of recognition units;
recognize the image data using a target model and output degrees of reliability corresponding to the target classes; and
adjust parameters of the target model in order to match the generated degrees of reliability corresponding to the target classes with the output degrees of reliability corresponding to the target classes.

2. The model generation apparatus according to claim 1, wherein the processor is configured to integrate degrees of reliability for classes included in the plurality of target classes among the degrees of reliability corresponding to classes output from the plurality of recognition units, and to generate the degrees of reliability corresponding to the target classes.

3. The model generation apparatus according to claim 1, wherein the processor is configured to perform a two-class recognition for each of the classes regarded as recognition targets in order to output a degree of reliability for a positive class and a degree of reliability for a negative class, the positive class indicating that the image data include a recognition target, the negative class indicating that the image data do not include the recognition target.

4. The model generation apparatus according to claim 3, wherein the reliability generation unit processor is configured to generate the degrees of reliability corresponding to the plurality of target classes by using degrees of reliability for the positive classes output from the plurality of recognition units.

5. The model generation apparatus according to claim 4, wherein the processor is configured to generate the degrees of reliability corresponding to the plurality of target classes, based on each ratio of degrees of reliability for positive classes with respect to a total of the degrees of reliability for the positive classes.

6. The model generation apparatus according to claim 5, wherein the processor is configured to set a value where the ratio is normalized, to a degree of reliability for each target class.

7. The model generation apparatus according to claim 3, wherein the processor is configured to recognize a different recognition target.

8. The model generation apparatus according to claim 7, wherein the processor is configured to recognize a recognition target of one class among the plurality of target classes.

9. The model generation apparatus according to claim 1, wherein the processor is configured to recognize a plurality of different recognition targets.

10. The model generation apparatus according to claim 9, wherein the processor is configured to recognize at least one class as the recognition target among the plurality of target classes.

11. A model generation method comprising:
recognizing image data by a plurality of recognition units using a learned model, and outputting degrees of reliability corresponding to classes regarded as recognition targets by respective recognition units;
generating first degrees of reliability corresponding to a plurality of target classes based on the degrees of reliability output from the plurality of recognition units;
recognizing the image data using a target model and outputting second degrees of reliability corresponding to the target classes; and
adjusting parameters of the target model in order to match the first degrees of reliability with the second degrees of reliability.

12. A non-transitory computer-readable recording medium storing a program, the program causing a computer to perform a process comprising:
recognizing image data by a plurality of recognition units using a learned model, and outputting degrees of reliability corresponding to classes regarded as recognition targets by respective recognition units;
generating first degrees of reliability corresponding to a plurality of target classes based on degrees of reliability output from the plurality of recognition units;
recognizing the image data using a target model and outputting second degrees of reliability corresponding to the target classes; and
adjusting parameters of the target model in order to match the first degrees of reliability with the second degrees of reliability.
